(19) United States
(12) Patent Application Publication
(10) Pub. No.: US 2004/0265098 A1
(43) Pub. Date: Dec. 30, 2004

(54) Bulk material loading device

(76) Inventor: Thomas M. DePierri, Baton Rouge, LA (US)

Correspondence Address: WARNER J DELAUNE JR, ADAMS AND REESE LLP, 450 LAUREL STREET, BATON ROUGE, LA, 70801, US

(21) Appl. No.: 10/609,184

(22) Filed: Jun. 26, 2003

(51) Int. Cl. B65G 1/00

(52) U.S. Cl. 414/296

(57) ABSTRACT

A bulk material loading device is provided for maximizing the fill efficiency of a compartment and for preventing unwanted spillage outside the compartment. The loading device comprises an upper casing assembly having an inlet for receiving a bulk material, and a motor having a shaft and a motor housing, wherein the motor housing is mounted to the upper casing assembly outside of the inlet. An impeller is in rotational communication with the motor shaft and aligned beneath the inlet. A shutter assembly is operatively connected between the motor housing and the upper casing assembly, and the shutter assembly is movable between a closed position and an open position. Preferably, a level sensor is positioned below the impeller for sensing and controlling the flow of bulk material from its source. The impeller comprises a lower portion which includes a plurality of vanes sized and positioned to disperse the bulk material at a predetermined trajectory from the device, and an upper portion which includes a surface formed to direct the material into the vanes.

### BACKGROUND OF THE INVENTION

I. Field of the Invention

The present invention relates generally to the loading of dry bulk materials from vessels into railcars, trucks, and other vehicles, and more particularly to those devices used to transfer such bulk materials in the most efficient manner possible.

II. Background and Prior Art

### A. Bulk Material Loading in General

In the movement of dry bulk material such as pelletized plastic, grain, and other products through the channels of trade, material is often transferred in bulk form from a large vessel into railcars and trucks. In the case of railcars intended for storage and transportation of these types of material, the railcars generally are divided into multiple compartments with a roof that is flat in the direction of the railcar's length, and slightly crowned in the lateral direction. These types of railcars are often referred to as “covered hopper cars,” and most hopper cars in use today have four compartments. Typically the compartments have different volumetric capacities, and there are either two or three hatches on the roof per compartment. For the larger capacity railcars, there are two hatches in each of the inner compartments and three hatches in each of the outer compartments. The total volumetric capacity of most hopper cars is between about 3,200 and 6,600 cubic feet, with the larger sizes having been introduced in more recent years as rail weight limits have increased.

When transporting bulk solid products by hopper car, the fee charged by the rail company is generally proportional to the number of cars used. Therefore, it is usually important to those paying for such shipping costs to maximize the amount of product which is loaded into the railcars. However, as a practical matter, it is almost impossible to achieve a 100% fill of the railcar's compartments. The cause of incomplete filling is that when bulk solids are loaded by gravity alone, the product's angle of repose causes the material to form a cone-shaped pile, thereby leaving a void space at the perimeter of the compartment once the top of the pile reaches the hatch. In past times, a variety of measures were employed to increase the amount of product in each compartment, sometimes referred to as maximizing the “fill efficiency.” These measures included filling from other hatches in the compartment, manually spreading out the material with rakes or the like, or physically shaking the entire car to cause the product to spread out. As those previous methods were inconvenient and time-consuming, special devices called “product spreaders” have been developed and used in the bulk solids industry for the last few decades. Product spreaders (also sometimes referred to as “trimmers”) are devices used to increase the volume of bulk solid products that can be loaded into a covered hopper car compartment from a single hatch by dispersing the material to the far corners of the compartment. Such devices are used primarily by the plastics industry to load pelletized plastic resins such as polyethylene, polypropylene, and similar products. Current manufacturers of product spreaders include Midwest International Standard Products, Inc., Bayshore Steel, Inc., DCL, Inc., and MAC Equipment, Inc.

As can be understood, increasing the average amount of product loaded into each railcar can therefore reduce transportation costs, and the cost savings will be generally proportional to the amount of the increase. Since such transportation costs can be a substantial proportion of a company's total operating costs, even relatively modest improvements in fill efficiency can have a significant impact on a company's profitability. Additional savings can be realized if the increased fill efficiencies are sufficient to reduce the size of a company's railcar fleet as there will be a proportional reduction in capital depreciation costs, maintenance costs, and related expenses.

### B. Product Spreader Theory

To better appreciate the novelty of the present invention, further detail is provided below as to the theory of operation of current product spreaders. A product spreader increases the volume of bulk solid material that can be loaded into a railcar compartment by changing the direction of the product flow from generally vertical to a more horizontal direction, distributing the material in a radial fashion with respect to vertical. This causes product to accumulate in an inverted cone-shaped pile around the perimeter of the compartment and fill generally from the outside toward the inside, significantly increasing the fill volume in the compartment when the product reaches the hatch.

Typical product spreaders accomplish this by directing the product over a multi-vane impeller rotating about a vertical axis. However, there are a number of other variations including elements resembling a rotating pipe elbow, a paddle wheel, pneumatic loaders, and similar devices. The direction of product flow into the spreader is generally vertical, so the axis of impeller rotation is parallel with the direction of product flow. In some cases, however, the axis of product flow is at a slight angle with respect to vertical, but the axis about which the spreader's impeller rotates remains vertical.

When product particles encounter the impeller, the vast majority of the particles encounter the leading surface of an impeller vane which has a significant tangential velocity by virtue of being rotated, normally by an electric, hydraulic, or pneumatic motor. The rotational speed of the impeller is typically 1,200 RPM or less, and several manufacturers utilize a reducing gearbox to achieve the desired impeller rotational speed. As a result of these collisions, the particles' direction is changed from vertical to some angle from vertical radially with respect to the centerline of the product spreader. The angle of the discharge relative to horizontal for each individual particle is affected by factors such as: (1) the vertical component of the velocity at the point of impact, (2) the tangential velocity of the impeller vane at the point of impact, (3) the coefficient of restitution of the product relative to the material of construction of the impeller vane, (4) the angle of the impeller vane compared to the axis of impeller rotation, and (5) other impeller-specific design features such as the shape of the impeller.

The ultimate goal of a product spreader is to achieve maximum fill efficiency. Most commercially available product spreaders available today will dramatically improve fill efficiencies compared to gravity loading, particularly if the comparison is for loading via a single hatch. While a typical fill efficiency figure for product spreaders is not available, recent field tests indicate that fill efficiencies could be substantially improved.

In spite of the improvements made by various manufacturers in product spreader technology, several deficiencies remain. Impeller designs can be enhanced to achieve higher fill efficiencies. Also, additional features can be implemented which help reduce spillage of the material outside the railcar compartments. Because possible exposure of personnel to workplace injuries is always a concern to companies, safety features can be added as well. Finally, level sensing features can be refined to improve control over the loading operation, further enhancing fill efficiency.

### SUMMARY OF THE INVENTION

Therefore, one object of the present invention is to provide a bulk material loading device which maximizes the fill efficiency of the compartment.

It is also an object of the present invention to provide a bulk material loading device which minimizes spillage of material outside the compartment.

A further object of the present invention is to provide a bulk material loading device which includes safety features to prevent injury to loading personnel.

Still another object of the present invention is to provide a bulk material loading device which includes level sensing features to provide a signal useful for closing the valve on the loading source when the compartment is nearly full or for modulating the loading rate.

Accordingly, a bulk material loading device is provided, comprising an upper casing assembly having an inlet for receiving a bulk material; a motor having a shaft and a motor housing, wherein the motor housing is mounted to the upper casing assembly outside of the inlet; an impeller rotatably mounted to the motor shaft, wherein the impeller is aligned beneath the inlet; and a shutter assembly operatively connected between the motor housing and the upper casing assembly, wherein the shutter assembly is movable between a closed position preventing the device from dispersing bulk material and an open position permitting the device to disperse bulk material.

In a preferred embodiment of the invention, the device further includes a level sensor operatively positioned below the impeller for sensing the accumulation of bulk material below the bulk material source. The inlet preferably comprises a hollow inverted frustum of a cone having an upper opening and a lower opening, wherein the size of the lower opening is predetermined relative to the size of the impeller. Regardless of size, the lower opening of the inlet cone is intended to concentrate the product stream directly over the impeller. The upper casing assembly also includes a mechanical stop for contacting the shutter assembly when the shutter assembly is in a fully open position.

In a more preferred embodiment, the impeller comprises an upper portion and a lower portion, wherein the lower portion includes a plurality of vanes sized and positioned to disperse the bulk material at a predetermined trajectory from the loading device, and wherein the upper portion includes a surface formed to direct the bulk material into the plurality of vanes.

The shutter assembly preferably comprises a cylindrical shutter having an upper rim and a lower rim; an upper shutter flange near the upper rim and extending radially from the shutter; and a lower shutter flange near the lower rim and extending radially from the shutter. A shutter contact surface is located on the motor housing to contact the shutter assembly in a closed position and retain residual bulk material inside the shutter assembly as the device is withdrawn from the compartment.

The upper casing assembly may also further comprise a lifting device operatively in contact with the shutter assembly for at least partially opening the shutter assembly to permit the release of residual bulk material from the device. The lifting device may comprise a plurality of air-actuated lifting cylinders operatively in contact with an identical number of lifting flanges positioned on the shutter assembly.

### BRIEF DESCRIPTION OF THE DRAWINGS

FIG. 1 is an elevation view of the present invention depicting the shutter assembly in an open position.

FIG. 2 is an elevation view of the present invention depicting the shutter assembly in a closed position.

FIG. 3 is an overall sectional view of the present invention illustrating further detail.

FIG. 4A is a sectional view of the motor housing, impeller, and level probe subassemblies.

FIG. 4B is a partial sectional view of the level probe mounting arrangement.

FIG. 5A is a top view of the impeller depicting the orientation of the vanes.

FIG. 5B is an elevation view of impeller further depicting the orientation of the vanes.

FIG. 6A is a more detailed sectional view of the shutter assembly in a closed position.

FIG. 6B is a more detailed sectional view of the shutter assembly in an open position.

FIG. 7 is a partial sectional view of the upper casing assembly.

FIG. 8 is a sectional view of the present invention in an operating environment illustrating the manner in which increased fill efficiency is achieved.

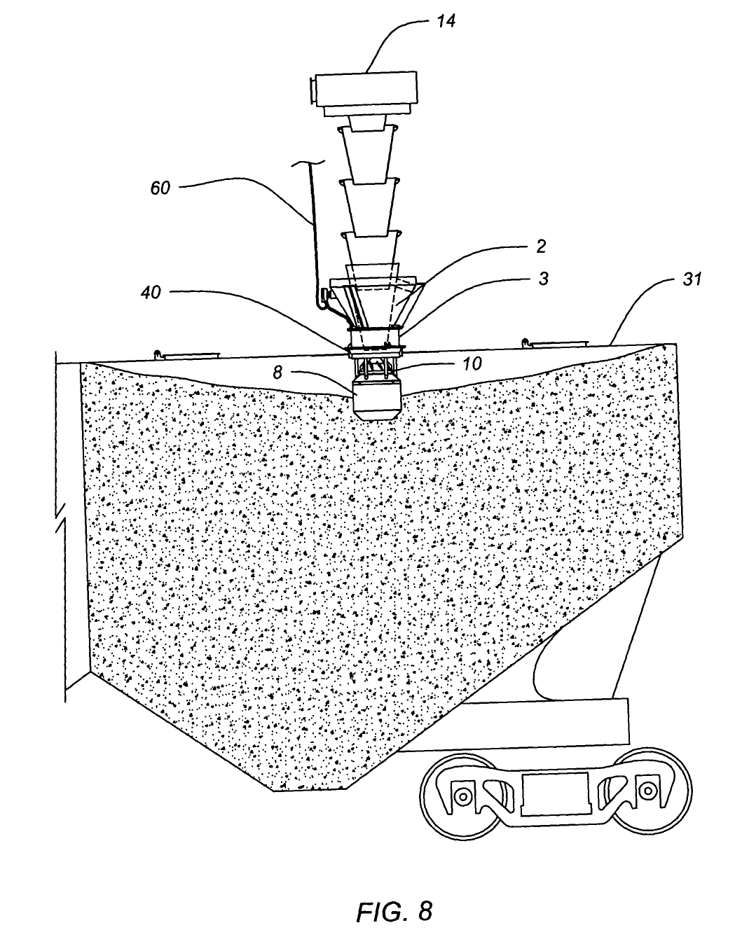

FIG. 9 is a partial sectional view of an alternative embodiment of the invention showing a non-motorized loading device with a level probe.

### DETAILED DESCRIPTION OF THE PREFERRED EMBODIMENTS

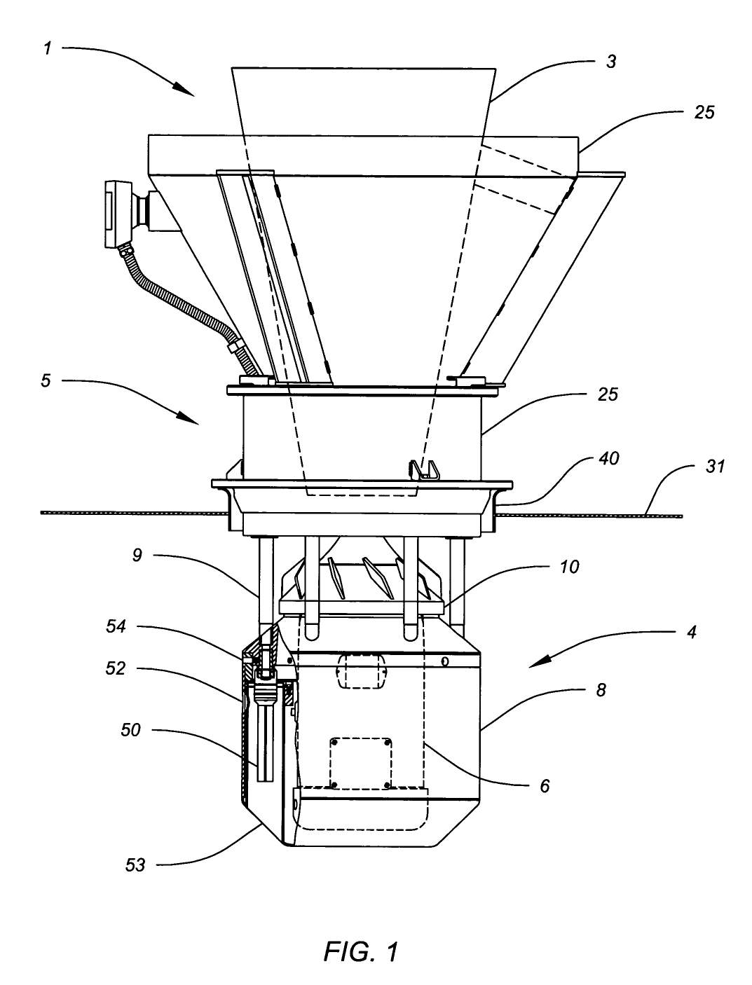

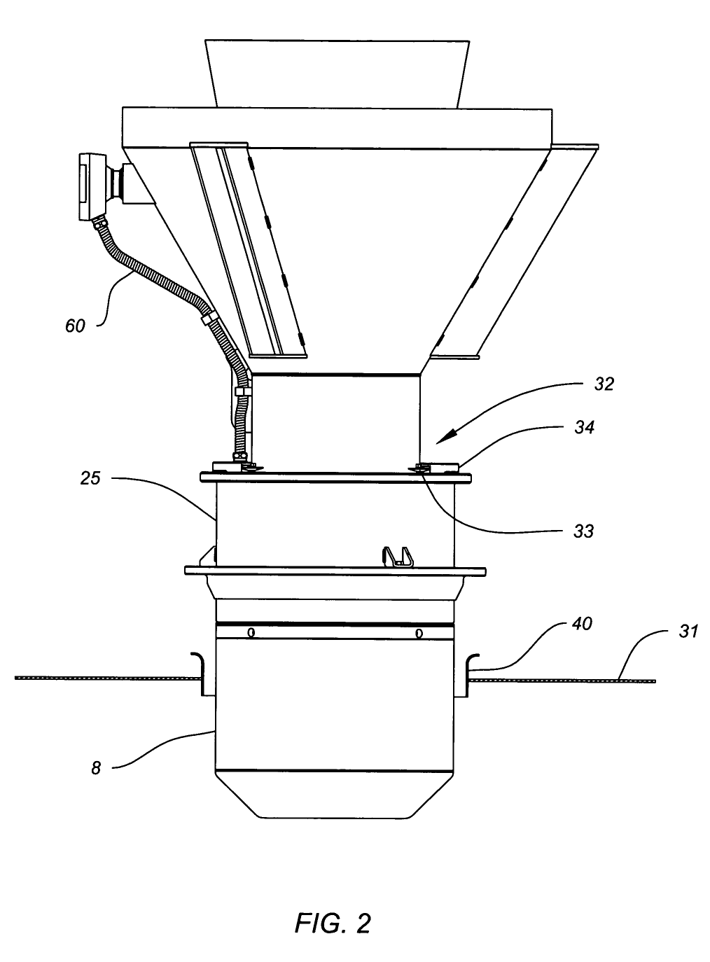

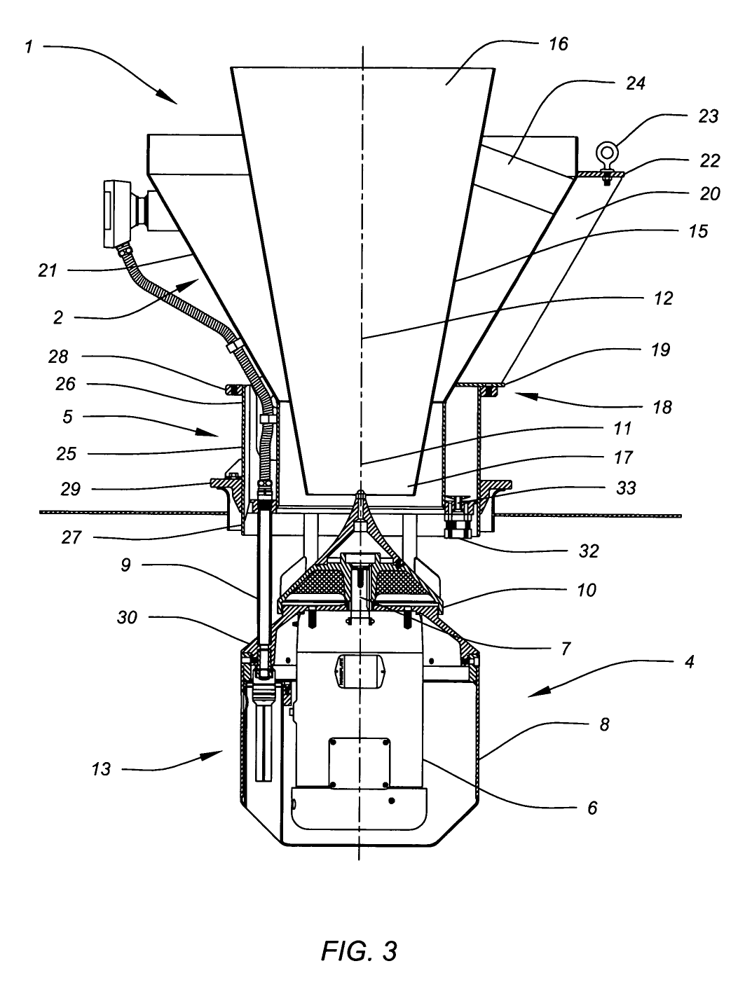

Turning now to FIGS. 1-3, a bulk material loading device 1 is illustrated, generally comprising an upper casing assembly 2 having an inlet 3 for receiving a bulk material, a lower drive assembly 4, and a shutter assembly 5. The drive assembly 4 includes a motor 6 having a shaft 7 which is contained within a motor housing 8. Although a wide range of parameters may affect the specific motor 6 chosen, the preferred specifications of motor 6 in prototypes constructed by the inventor include a power capacity of about 5 HP and a maximum speed of about 1200 RPM. A suitable motor 6 conforming to the function described herein may be obtained from Baldor Electric Company, at http://www.baldor.com, including additional technical details relating to its installation and operation. The drive assembly 4 is mounted to the upper casing assembly 2 outside of the inlet 3 by a plurality of rigid tubular spacers 9. An impeller 10 is rotatably mounted to the motor shaft 7, and the rotational axis 11 of the impeller 10 is approximately aligned beneath the central axis 12 of the inlet 3. The shutter assembly 5 is operatively connected between the motor housing 8 and the upper casing assembly 2, wherein the shutter assembly 5 is movable between a closed position against the motor housing 8 preventing the device 1 from dispersing material, and an open position against the upper casing assembly 2 permitting the device 1 to disperse material. It should be noted that FIGS. 1 and 3 depict the invention in an open material-dispensing position with respect to a compartment 31 and hatch 40, whereas FIG. 2 depicts the invention in a closed non-dispensing position. Unless otherwise noted herein, most materials of construction are preferably stainless steel. Although many parts may be fabricated from aluminum, the decrease in overall weight of the device is not particularly important because the loading device is lifted and moved by predominantly by other machinery.

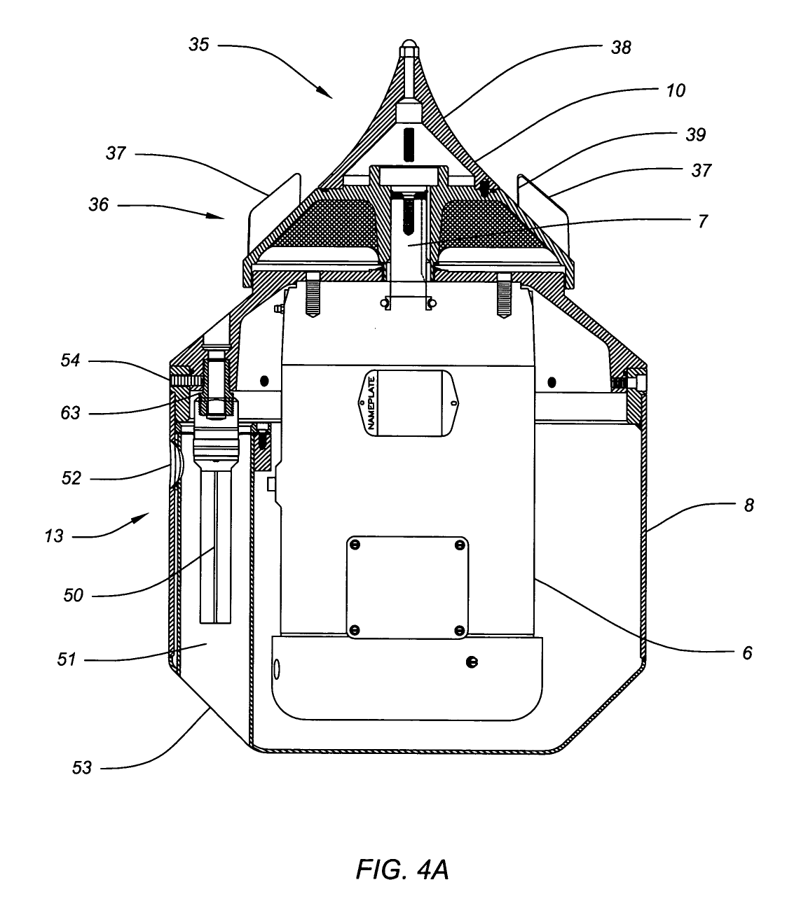

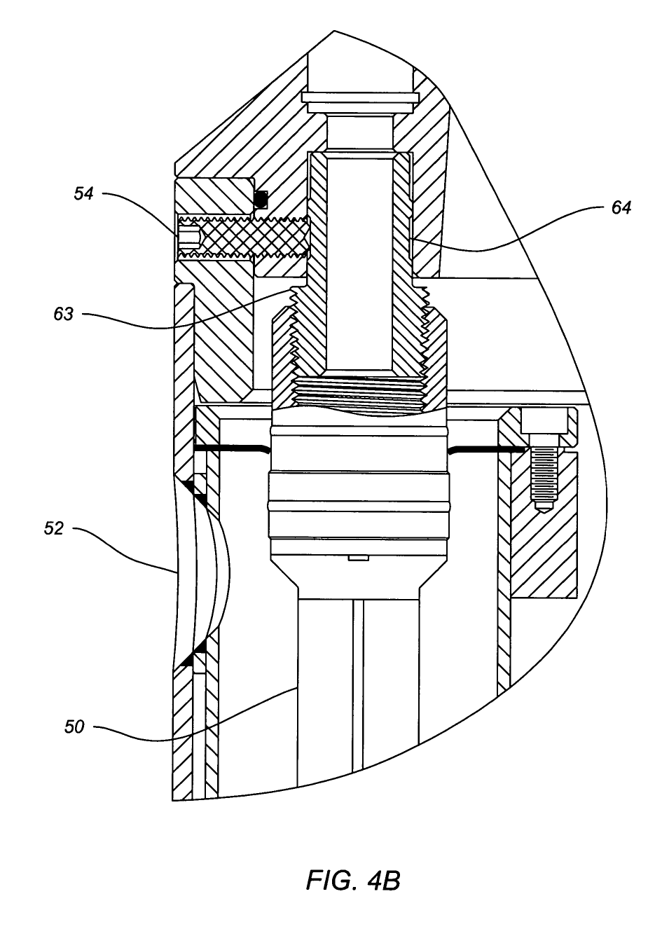

In a preferred embodiment of the invention, the device 1 further includes a level sensing assembly 13, shown best in FIG. 4A, operatively positioned below the impeller 10 for sensing the accumulation of bulk material below the bulk material source 14. As the level of product within compartment 31 rises, the product makes contact with the level sensing assembly 13, which causes an electrical relay (not shown but understood to those of ordinary skill) to change its state. The state of the electrical relay can be used, through suitable wiring 60, to electronically control the valve permitting material to flow from the material source 14 and/or to activate a visual or audible alarm. If desired, it can also serve as back-up instrumentation for occasions where the primary means for determining when loading should be stopped malfunctions. Level sensing assembly 13 preferably includes a piezoelectric vibratory level probe 50 positioned within a tubular well 51 within the motor housing 8. A suitable level probe 50 conforming to the foregoing description and function may be obtained from Monitor Technologies, LLC, at htp://www.monitortech.com, including additional technical details relating to its installation and operation. Level probe 50 is preferably fitted with a cylindrical adaptor 63 threadably mated to the internal mounting threads of the level probe 50. With the adaptor 63 installed, the level probe 50 may be inserted into a counterbore socket in the motor housing 8 and retained in place by a set screw 54 located in the motor housing 8 and tightened against a circumferential groove 64 formed on the adaptor 63. Mounting the level probe 50 in this manner provides several important advantages. First, housing the level probe 50 within a tubular well 51 provides a high degree of physical protection for level probe 50 while the device 1 is handled outside of compartment 31, thereby preventing damage to the probe. Second, installation and removal of the level probe 50 while the lower portion of the motor housing 8 is in place are facilitated because the level probe 50 does not have to be unscrewed for such installation and removal. Once the set screw 54 is loosened, the level probe and adapter can be inserted or withdrawn axially as an assembly. Another benefit of this mounting method is that since the adapter 63 is threadably mated to the level probe 50 prior to installing the probe onto device 1, it avoids twisting the attached electrical cable. Finally, tightening the set screw 54 against the groove 64 permits slight deformation of the adaptor material without jeopardizing the ability to withdraw the level probe 50 from its mounting socket.

With further reference to FIG. 4A, an inlet port 52 in the side of the motor housing 8 is used to expose the probe 50 to product when the compartment 31 is nearly full, allowing product to spill into the well 51 and eventually reach the bottom of the probe 50. By varying the height and size of the inlet port 52, the actuation level of the level probe 50 can be varied without changing the height of the level probe 50. The latter affects actuation level, because the size of the inlet port 52 influences the rate at which material flows into the tubular well 51, which in turn influences the delay between the time material begins to flow into the well 51 and the time the level probe 50 actuates. As the entire device 1 is retracted from the hatch 40, the product simply drains by gravity through an opening 53 near the bottom of the motor housing 8 into the loaded compartment 31.

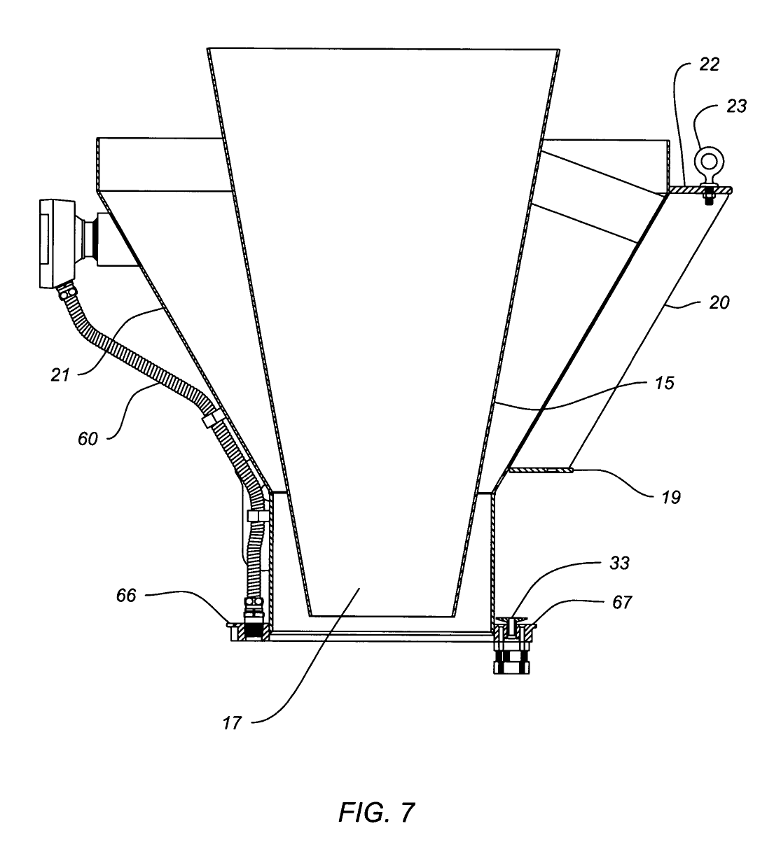

With specific reference to FIGS. 3 and 7, the inlet 3 preferably comprises a hollow inverted frustum of a cone 15 having an upper opening 16 and a lower opening 17, wherein the size of the lower opening 17 is predetermined relative to the size of the impeller 10. Regardless of size, the lower opening 17 of the inlet cone 15 is intended to concentrate the product stream directly over the impeller 10. The upper casing assembly 2 also includes a mechanical stop 18 for contacting the shutter assembly 5 when it achieves a fully open position. Preferably, the mechanical stop 18, as shown in the figures, is a lower plate 19 at the base of at least three gussets 20 attached to the outer casing 21. The gussets 20 reinforce the outer casing 21 and further include an upper plate 22 which can be fitted with eye bolts 23 to facilitate lifting the device 1. At least three radial support ribs 24 are attached between the outer casing 21 and the inlet cone 15 to support and maintain the concentricity of the inlet cone 15 with respect to the outer casing 21. Preferably, the ribs 24 are aligned radially with gussets 20 to increase the structural rigidity of the upper casing assembly 2.

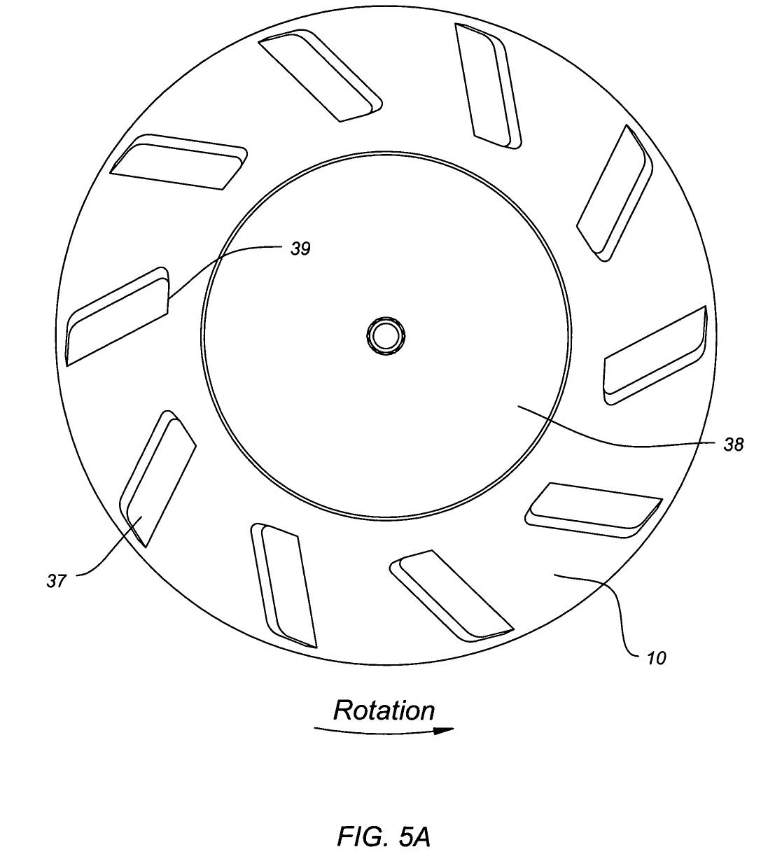

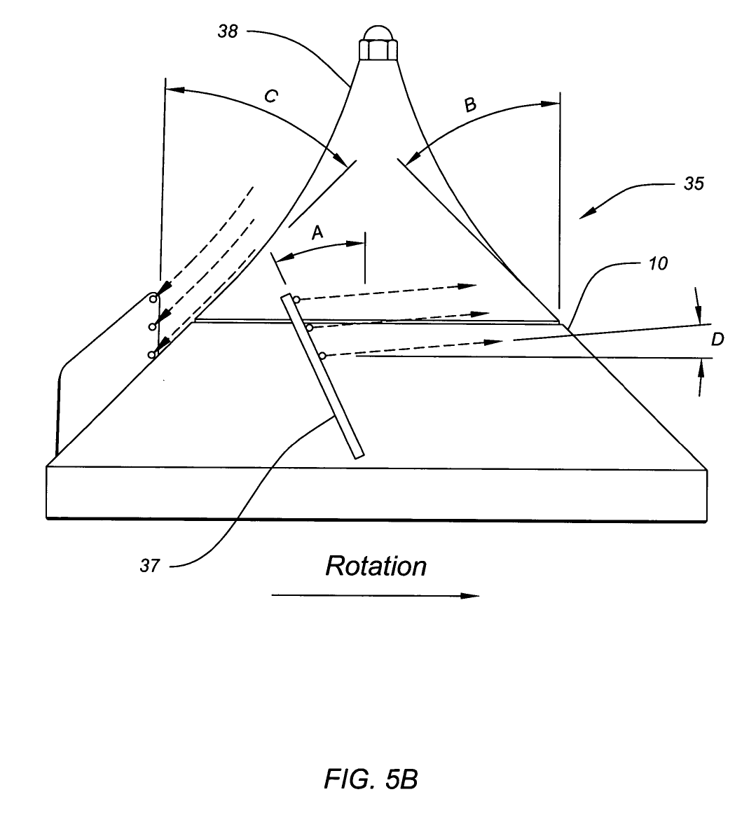

In a more preferred embodiment best illustrated in FIG. 4A, the impeller 10 comprises an upper portion 35 and a lower portion 36, wherein the lower portion 36 includes a plurality of vanes 37 sized and positioned to disperse the bulk material at a predetermined trajectory from the loading device 1, and wherein the upper portion 35 includes a guiding surface 38 formed to direct the bulk material into the plurality of vanes 37. The overall design of the impeller 10 is intended to achieve a product discharge trajectory that will increase fill efficiency compared to existing product spreaders. The product discharge trajectory is a function of both the average angle of product discharge with respect to vertical, as well as the velocity of product discharge immediately after impact with a vane 37. First, as can been seen more clearly in FIGS. 5A and 5B, the impeller 10 is fitted with vanes 37 that are tilted at a pitch angle A of approximately 20 to 30 degrees with respect to vertical. However, it should be noted that the pitch angle A may be any angle chosen to produce a generally horizontal or slightly upward trajectory of the material. Prior designs incorporate vanes that are oriented vertically, i.e., parallel with the inlet flow axis 12, which does little to eliminate the vertical velocity component of the product stream. The pitch angle A for the vanes 37 is chosen based on several variables including the vertical or downward velocity of the product particles, the coefficient of restitution of the product particles relative to the material of construction of the impeller vane 37, the tangential velocity of the impeller vanes 37 at the average impact radius, and the desired discharge trajectory (preferably slightly upward, between about 5 and 10 degrees with respect to horizontal). In addition to producing a more desirable discharge trajectory, the vanes 37 oriented at pitch angle A also produce a higher particle discharge velocity for a given impeller vane 37 tangential velocity. This is important because the horizontal distance from the center of the loading hatch 40 to the farthest corner of the compartment 31 on modem hopper cars is approximately 11 feet, which requires a significant discharge velocity to reach.

As shown in FIG. 5B, the guiding surface 38 on the upper portion 35 of the impeller 10 gradually changes the direction of product particles from generally vertical to an angle B which is small enough to prevent material from accumulating in the device when the impeller 10 is static. For many bulk materials, an angle B of approximately 40 to 50 degrees from vertical is sufficient to prevent such accumulation. As the product stream flows over the guiding surface 38, the material forms a layer that generally conforms to the guiding surface 38. Since the diameter of the upper portion 35 of the impeller 10 increases in the direction of flow, as the product flows down over the guiding surface 38, the thickness of the product layer becomes proportionally thinner in the direction normal to the guiding surface 38. The significance of changing the direction prior to being impacted by the vanes is twofold. First, the power requirement to achieve a desired trajectory and discharge velocity is reduced because a horizontal velocity component has been imparted by virtue of the reaction between the guiding surface 38 and the product stream, which requires no power from the motor 6 rotating the impeller 10. Second, it allows use of vanes 37 that are shaped specifically to minimize collisions between particles that have been impacted by an impeller vane 37 and particles that have yet to be impacted while also maintaining a reasonably small range of tangential velocities of the impeller vane 37 within the expected impact region.

Furthermore, the impeller 10 incorporates a comparatively large number of relatively small vanes 37 with a unique shape designed to minimize collisions between particles that have been impacted by an impeller vane 37 and ones that have yet to be impacted. The resultant advantage is that a more concentrated, predictable discharge is achieved with less wasted energy, thereby increasing fill efficiencies. Specifically, as depicted best in FIG. 5B, the shape of the vanes 37 are such that the inner (leading) edge 39 is oriented at an angle C with respect to the direction of product flow, and since the product particle direction has been changed to approximately angle B from vertical by virtue of the guiding surface 38 angle, this causes a higher proportion of particles that are toward the outer regions of the product stream to be impacted by the upper portion of the vanes 37, and vice versa, thereby minimizing such collisions. An analogy of this phenomenon is a typical highway intersection with multiple left turn lanes. The angle C of the leading edge 39 with respect to the line of product flow increases the number of product particles that stay in the proper lane when making a left turn, thereby minimizing collisions.

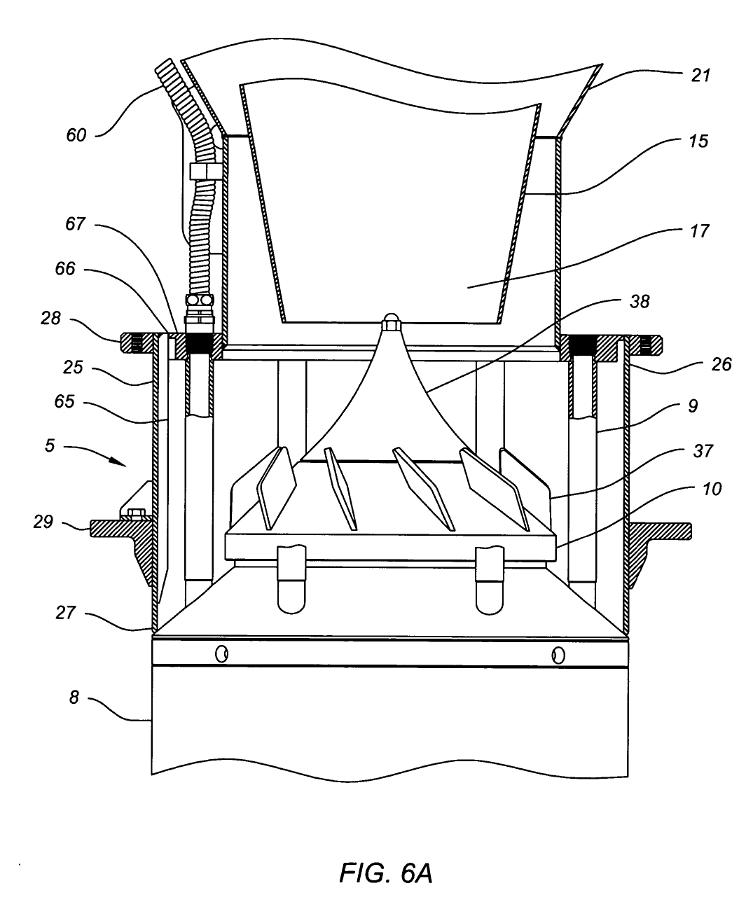

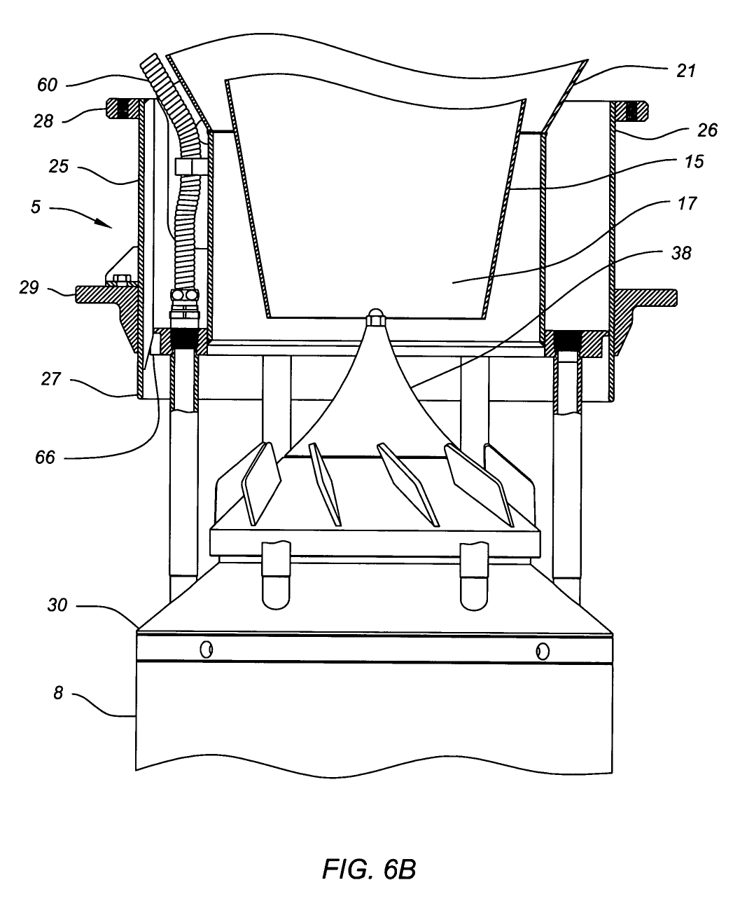

Turning now to FIGS. 6A and 6B, the shutter assembly 5 preferably comprises a cylindrical shutter 25 having an upper rim 26 and a lower rim 27. An upper shutter flange 28 is attached to the shutter 25 near the upper rim 26 and extends radially from the shutter 25. A lower shutter flange 29 is attached to the shutter 25 near the lower rim 27 and also extends radially from the shutter 25. A vertically oriented key 65 is attached to the inner surface of the shutter 25 and extending from the upper rim 26 to adjacent the lower rim 27. The key 65 resides within a recess 66 in the casing flange 67 so that the shutter assembly 5 is constrained from rotation about the vertical axis 11. A shutter contact surface 30 is located on the motor housing 8 to contact the lower rim 27 of the shutter 25 in a closed position and retain residual bulk material inside the shutter assembly 5 as the device 1 is withdrawn from a compartment 31. From the foregoing description, it can be seen that the shutter assembly 5 prevents spillage if a compartment 31 is overfilled. The shutter assembly 5, which normally remains in a closed position against contact surface 30 due to the force of its own weight, also serves as a safety guard for the impeller 10 while the device 1 is retracted. The shutter assembly 5 automatically opens upon insertion of the device 1 into the compartment hatch 40, because it remains in contact with the rim of hatch 40 while the remainder of the device 1 descends into the compartment 31. Shutter assembly 5 then closes automatically by its own weight when the device 1 is retracted from hatch 40. Since the shutter assembly 5 closes when the device 1 is retracted, if a compartment 31 has been overfilled, it will substantially prevent product from draining out when the device 1 is retracted. By substantially reducing the extent of spillage, it becomes feasible to increase loading weight limits to the maximum possible without suffering the offsetting cost of scrap losses due to spillage.

An additional benefit of the shutter assembly 5 is that slight settlement of the hopper car due to the addition of product weight during loading will not cause the lower flange 29 to separate from the hatch 40, which can result in product spillage. The shutter assembly 5 will simply slide down and maintain contact with the hatch 40 until the entire device 1 is withdrawn.

Further referencing FIGS. 2 and 3, the upper casing assembly 2 may also further comprise a lifting device 32 operatively in contact with the shutter assembly 5 for at least partially opening the shutter assembly 5 to permit the release of residual bulk material from the device 1. The lifting device 32 may comprise a plurality of (preferably three) air-actuated single-action lifting cylinders 33, connected to an external common compressed air source, operatively in contact with an identical number of lifting flanges 34 positioned on the shutter assembly 5. Suitable air cylinders 33 capable of performing the described function may be obtained from the Bimba Manufacturing Company at http://www.bimba.com, including additional technical information relating to their installation and operation. In operation, when the device 1 is retracted from the compartment 31, the shutter assembly 5 will rest upon the contact surface 30, and the lifting flanges 34 will reside immediately above the lifting cylinders 33. The lifting cylinders 33 can be actuated by the compressed air source, causing each cylinder 33 to exert an upward force upon its respective lifting flange 34, thereby lifting shutter assembly 5 by a distance approximately equal to the short travel of the cylinders 33, typically about three quarters of an inch to one inch. Opening the shutter assembly 5 by this amount is generally sufficient to allow residual material to exit the device 1.

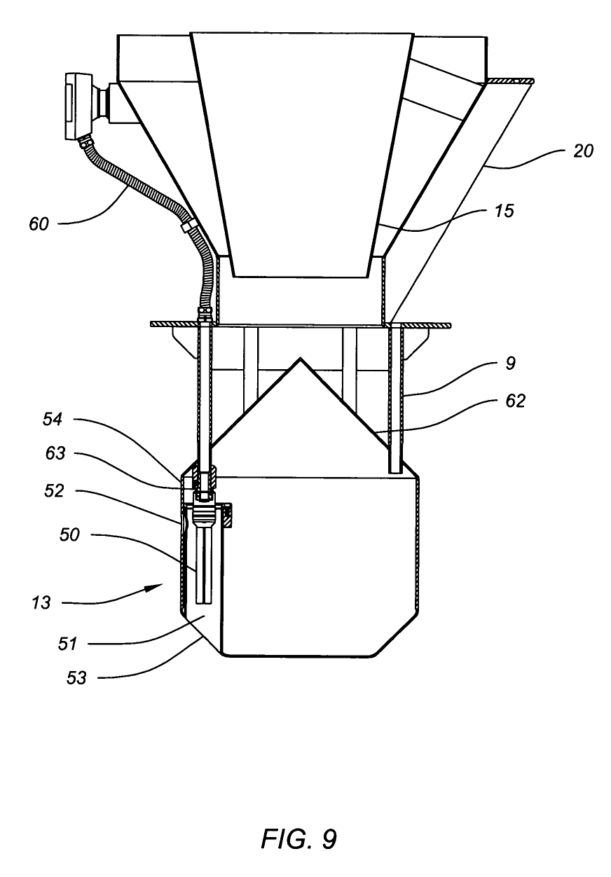

In FIG. 9, an alternative and simpler embodiment of the present invention is shown which does not include a motorized spreader or shutter assembly, but which still possesses all of the advantages of the level sensing assembly 13. In operation of this embodiment, bulk material flows from the material source 14 and travels down the inverted cone 15 similar to the preferred embodiment. However, rather than being dispersed by a spreading system, the material is deflected from a static material guide 62, such as a circular cone, and exits the device through the force of gravity. As material accumulates around the base of the device, it will eventually enter inlet port 52 and tubular well 51, and subsequently contact the bottom of vibratory level probe 50. Reaching the operative level of the level probe 50 causes an electrical relay to change its state, which, as in the case of the preferred embodiment, may be used to control the valve through which the material flows and/or to activate a visual or audible alarm.

Although exemplary embodiments of the present invention have been shown and described, many changes, modifications, and substitutions may be made by one having ordinary skill in the art without necessarily departing from the spirit and scope of the invention. For example, it should be understood to those of ordinary skill that the invention may be employed not only with the covered hopper cars described above, but also with many other variants of storage and transportation vehicles capable of holding non-plastic bulk products, such as grain and other industrial materials.

I claim:

1. A bulk material loading device, comprising:
(a) an upper casing assembly having inlet means for receiving a bulk material;
(b) a motor having a shaft and a motor housing, wherein said motor housing is mounted to said upper casing assembly outside of said inlet means;
(c) an impeller in rotational communication with said shaft of said motor, wherein said impeller is aligned beneath said inlet means; and
(d) a shutter assembly operatively connected between said motor housing and said upper casing assembly, wherein said shutter assembly is movable between a closed position preventing said device from dispersing said bulk material and an open position permitting said device to disperse said bulk material.

2. The device of claim 1, further comprising level sensing means operatively positioned below said impeller for sensing an accumulation of said bulk material.

3. The device of claim 1, wherein said shutter assembly comprises:
(a) a cylindrical shutter having an upper rim and a lower rim; and
(b) a shutter flange extending radially from said shutter.

4. The device of claim 1, wherein said motor housing includes a shutter contact surface formed to contact said shutter assembly in a closed position and retain residual bulk material inside said device.

5. The device of claim 1, wherein said upper casing assembly further comprises lifting means operatively in contact with said shutter assembly for at least partially opening said shutter assembly to permit the release of residual bulk material from said device.

6. The device of claim 5, wherein said shutter assembly further comprises a plurality of lifting flanges, and wherein said lifting means comprises a plurality of lifting actuators operatively in contact with said lifting flanges.

7. The device of claim 6, wherein said lifting actuators are pneumatic.

8. A bulk material loading device, comprising:
(a) an upper casing assembly having inlet means for receiving a bulk material;
(b) a motor having a shaft and a motor housing, wherein said motor housing is mounted to said upper casing assembly outside of said inlet means; and
(c) an impeller in rotational communication with said shaft of said motor, wherein said impeller is aligned beneath said inlet means, wherein said impeller comprises an upper portion and a lower portion, wherein said lower portion includes a plurality vanes adapted to disperse said bulk material, and wherein said upper portion includes a surface formed to direct said bulk material into said plurality of vanes.

9. The device of claim 8, further comprising a shutter assembly operatively connected between said motor housing and said upper casing assembly, wherein said shutter assembly is movable between a closed position preventing said device from dispersing said bulk material and an open position permitting said device to disperse said bulk material.

10. The device of claim 8, further comprising level sensing means operatively positioned below said impeller for sensing an accumulation of said bulk material.

11. The device of claim 9, wherein said shutter assembly comprises:
(a) a cylindrical shutter having an upper rim and a lower rim; and
(b) a shutter flange extending radially from said shutter.

12. The device of claim 9, wherein said motor housing includes a shutter contact surface formed to contact said shutter assembly in a closed position and retain residual bulk material inside said device.

13. The device of claim 9, wherein said upper casing assembly further comprises lifting means operatively in contact with said shutter assembly for at least partially opening said shutter assembly to permit the release of residual bulk material from said device.

14. The device of claim 13, wherein said shutter assembly further comprises a plurality of lifting flanges, and wherein said lifting means comprises a plurality of lifting actuators operatively in contact with said lifting flanges.

15. The device of claim 14, wherein said lifting actuators are pneumatic.

16. A bulk material loading device, comprising:
(a) an upper casing assembly having inlet means for receiving a bulk material;
(b) a motor having a shaft and a motor housing, wherein said motor housing is mounted to said upper casing assembly outside of said inlet means; and
(c) an impeller in rotational communication with said shaft of said motor, wherein said impeller is aligned beneath said inlet means, wherein said impeller includes a plurality of vanes, and wherein said vanes are oriented at a predetermined non-zero angle with respect to vertical.

17. The device of claim 16, further comprising a shutter assembly operatively connected between said motor housing and said upper casing assembly, wherein said shutter assembly is movable between a closed position preventing said device from dispersing said bulk material and an open position permitting said device to disperse said bulk material.

18. The device of claim 16, further comprising level sensing means operatively positioned below said impeller for sensing an accumulation of said bulk material.

19. The device of claim 17, wherein said shutter assembly comprises:
(a) a cylindrical shutter having an upper rim and a lower rim; and
(b) a shutter flange extending radially from said shutter.

20. The device of claim 17, wherein said motor housing includes a shutter contact surface formed to contact said shutter assembly in a closed position and retain residual bulk material inside said device.

21. The device of claim 17, wherein said upper casing assembly further comprises lifting means operatively in contact with said shutter assembly for at least partially opening said shutter assembly to permit the release of residual bulk material from said device.

22. The device of claim 21, wherein said shutter assembly further comprises a plurality of lifting flanges, and wherein said lifting means comprises a plurality of lifting actuators operatively in contact with said lifting flanges.

23. The device of claim 22, wherein said lifting actuators are pneumatic.

24. A bulk material loading device, comprising:
(a) an upper casing assembly having inlet means for receiving a bulk material;
(b) a motor having a shaft and a motor housing, wherein said motor housing is mounted to said upper casing assembly outside of said inlet means;
(c) an impeller in rotational communication with said shaft of said motor, wherein said impeller is aligned beneath said inlet means; and
(d) level sensing means operatively positioned below said impeller for sensing an accumulation of said bulk material in a container when said bulk material in said container is at a predetermined height above an operative level of said level sensing means.

25. The device of claim 24, further comprising a shutter assembly operatively connected between said motor housing and said upper casing assembly, wherein said shutter assembly is movable between a closed position preventing said device from dispersing said bulk material and an open position permitting said device to disperse said bulk material.

26. The device of claim 24, wherein said impeller comprises an upper portion and a lower portion, wherein said lower portion includes a plurality of vanes adapted to disperse said bulk material, and wherein said upper portion includes a surface formed to direct said bulk material into said plurality of vanes.

27. The device of claim 24, wherein said impeller includes a plurality of vanes, and wherein said vanes are oriented at a predetermined non-zero angle with respect to vertical.

28. The device of claim 25, wherein said shutter assembly comprises:
(a) a cylindrical shutter having an upper rim and a lower rim; and
(b) a shutter flange extending radially from said shutter.

29. The device of claim 24, wherein said motor housing includes a shutter contact surface formed to contact said shutter assembly in a closed position and retain residual bulk material inside said device.

30. The device of claim 24, wherein said upper casing assembly further comprises lifting means operatively in contact with said shutter assembly for at least partially opening said shutter assembly to permit the release of residual bulk material from said device.

31. The device of claim 30, wherein said shutter assembly further comprises a plurality of lifting flanges, and wherein said lifting means comprises a plurality of lifting actuators operatively in contact with said lifting flanges.

32. The device of claim 31, wherein said lifting actuators are pneumatic.

33. The device of claim 24, wherein said level sensing means comprises a level probe attached adjacent to said motor housing, said level probe being responsive to contact with said bulk material.

34. The device of claim 33, wherein said level probe is a piezoelectric-based vibratory probe.

35. The device of claim 33, wherein said level probe is protected within a well having an inlet port and a bottom opening.

36. The device of claim 33, wherein said level probe is detachably mounted by a set screw.

37. A bulk material loading device, comprising:
(a) an upper casing assembly having inlet means for receiving a bulk material;
(b) a material guide, positioned below said inlet means, having a surface capable of deflecting said bulk material; and
(c) level sensing means operatively positioned below said material guide for sensing an accumulation of said bulk material in a container when said bulk material in said container is at a predetermined height above an operative level of said level sensing means. 38. The device of claim 37, wherein said level sensing means comprises a level probe attached below said material guide, said level probe being responsive to contact with said bulk material. 39. The device of claim 38, wherein said level probe is a piezoelectric-based vibratory probe. 40. The device of claim 38, wherein said level probe is protected within a well having an inlet port and a bottom opening. 41. The device of claim 38, wherein said level probe is detachably mounted by a set screw.
